(19) United States
(12) Patent Application Publication
(10) Pub. No.: US 2008/0013446 A1
(43) Pub. Date: Jan. 17, 2008

(54) Methods, systems, and computer program products for selectively limiting access to signaling network nodes that share a point code

(75) Inventors: Michael Y. Xu, Raleigh, NC (US); Devesh Agarwal, Raleigh, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/786,763

(22) Filed: Apr. 12, 2007

Related U.S. Application Data
(60) Provisional application No. 60/791,394, filed on Apr. 12, 2006.

(51) Int. Cl. H04J 3/14

(52) U.S. Cl. 370/217

(57) ABSTRACT

Methods, systems, and computer program products for selectively limiting access to signaling network nodes that share a point code are disclosed. According to one method, first and second destination nodes are provisioned to be identified by a common point code. Messages are routed to the first and second destination nodes respectively using first and second exception routes that are keyed by different combinations of parameters that include the common point code as a destination point code (DPC). At least one default route is provided to the first and second destination nodes. Failure of at least one of the first exception route and the first destination node is detected. In response to detecting the failure, fallback access to the second destination node via the at least one default route is restricted.

### RELATED APPLICATIONS

The present application claims the benefit of U.S. Provisional Patent Application Ser. No. 60/791,394, filed Apr. 12, 2006; the disclosure of which is incorporated herein by reference in its entirety.

### TECHNICAL FIELD

The subject matter described herein relates to routing signaling messages and utilizing exception routes in a communications network. More particularly, the subject matter described herein relates to methods, systems, and computer program products for selectively limiting access to signaling network nodes that share a point code.

### BACKGROUND

In a signaling system 7 (SS7) network, signal transfer point (STP) nodes are employed to route SS7 signaling messages through the network. Conventional SS7 routing is based on a destination point code (DPC) value that is contained in a message transfer part (MTP) routing label in an SS7 message. Such routing is commonly referred to as MTP routing. An exemplary SS7 message signaling unit (MSU) 100 is shown in FIG. 1. In FIG. 1, MSU 100 includes an originating point code (OPC) 102 and DPC 104. Notably, the DPC contained in the MTP routing label of an SS7 message is used to determine over which SS7 signaling linkset the message should be transmitted.

Signaling links connected to an STP are organized into groups of up to 16. Each group is known as a linkset. Furthermore, all signaling links in a given linkset terminate at the same adjacent node. In the case of a combined linkset, all signaling links in a given linkset terminate at the same mated pair of adjacent nodes. STP nodes are typically provisioned to distribute messages across all of the links in a linkset for load sharing purposes.

In addition to signaling links and linksets, a routing entity, commonly referred to as a signaling route, is also defined at an STP. A signaling route may include one or more signaling linksets. An STP may maintain a cost value associated with each route, and route availability is affected by received network management information. When multiple routes exist to the same destination, the STP can select the lowest cost route to the destination. Thus, all messages received at an STP that are addressed to a particular DPC are typically routed to the destination via the first available, lowest cost route. The overall route selection is typically based on the DPC specified in the message being routed. Such a routing mechanism ensures that a message will be routed to the appropriate destination corresponding to the DPC.

To illustrate conventional MTP routing, a sample SS7 network 200 is presented in FIG. 2. In FIG. 2, signaling network 200 includes a pair of originating end office (EO) nodes 202 and 204, a first STP node 206, a second STP node 208, a third STP node 210, and destination end office 212. Originating end office 202 has an SS7 point code of 244-2-1 and is coupled to STP 206, which has a point code of 1-1-1. Signaling linkset LS3 interconnects end office 202 and STP 206. As such, the point code 244-2-1 is referred to as an adjacent point code (APC) with respect to STP 206. Similarly, originating end office 204 has a point code of 5-2-1 and is coupled to STP 206 via signaling linkset LS4. STP 206 is coupled to adjacent STP 208 via LS1. STP 208 has a point code of 10-10-10. STP 206 is coupled to adjacent STP 210 via LS2. STP 210 has a point code of 248-10-10.

FIG. 3 is an exemplary routing table 300 that illustrates routing data that may be maintained by STP 206. In table 300, the exemplary routing table includes a route DPC field, a linkset name (LSN) field, a linkset adjacent point code (APC) field, and a route cost (RC) field. The information contained in table 300 is used by routing logic in STP 206 to determine how to direct or route a received message. In the message routing scenario illustrated in FIG. 2, STP 206 receives a first SS7 signaling message M1 from originating EO 202. For purposes of illustration, it is assumed that message M1 is addressed to the DPC 145-2-1, which corresponds to EO 212. Upon receiving message M1, routing logic in STP 206 accesses the routing information contained in table 300 and selects an outbound signaling linkset associated with the lowest cost route to 145-2-1. In this example, the selected signaling linkset is LS1, which is connected to adjacent STP 208. Consequently, the message is transmitted to STP 208 via linkset LS1. STP 208, upon receiving the message M1, performs similar routing processing procedure and transmits the message across another signaling linkset to destination EO 212.

In the second message routing scenario illustrated in FIG. 2, a message M2 is sent by end office 204. The DPC in the message is set to 145-2-1, which corresponds to EO 212. Message M2 is received by STP 206, which again accesses the routing information contained in Table 302 and selects an outbound signaling linkset corresponding to the lowest cost route to 145-2-1. Once again, the lowest cost route is selected, which corresponds to signaling linkset LS1 (assuming LS1 is not congested or out of service) and the message M2 is transmitted to STP 208 via linkset LS1. STP 208, upon receiving message M2, transmits the message to destination EO 212.

The routing process illustrated above has significant drawbacks in situations where network operators need the ability to control the routing of some or all signaling messages traversing a network. For example, on the occasion where a new signaling node (e.g., an SCP) is to be added to an existing network the originating signaling points (e.g., mobile switching centers (MSCs)) typically need to be reprovisioned with a corresponding destination point code so that the new signaling node can be contacted. To avoid the inconveniences and complications associated with reprovisioning the originating signaling points, the new signaling node can be assigned a point code that is currently used by an existing signaling point. Allowing two or more nodes to share a point code where each node processes a portion of the signaling message traffic in the network works well when both nodes and routes to both nodes are available. However, if either node failed, it would be desirable to limit the flow of traffic to the other node to prevent the available node from being overwhelmed. However, because both nodes share a point code, there is no current mechanism for preventing traffic from falling back to the available node and immediately overwhelming that node. Accordingly, in light of these difficulties, there exists a need for methods, systems, and computer program products for selectively limiting access to signaling network nodes that share a point code.

### SUMMARY

Methods, systems, and computer program products for selectively limiting access to signaling network nodes that share a point code are disclosed. According to one method, first and second destination nodes are provisioned to be identified by a common point code. Messages are routed to the first and second destination nodes respectively using first and second exception routes that are keyed by different combinations of parameters that include the common point code as a destination point code (DPC). At least one default route is provided to the first and second destination nodes. Failure of at least one of the first exception route and the first destination node is detected. In response to detecting the failure, fallback access to the second destination node via the at least one default route is restricted.

The subject matter described herein for selectively limiting access to network nodes that share a point code may be implemented using a computer program product comprising computer executable instructions embodied in a computer readable medium. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram illustrating exemplary parameters contained within a signaling system 7 (SS7) message signaling unit (MSU);

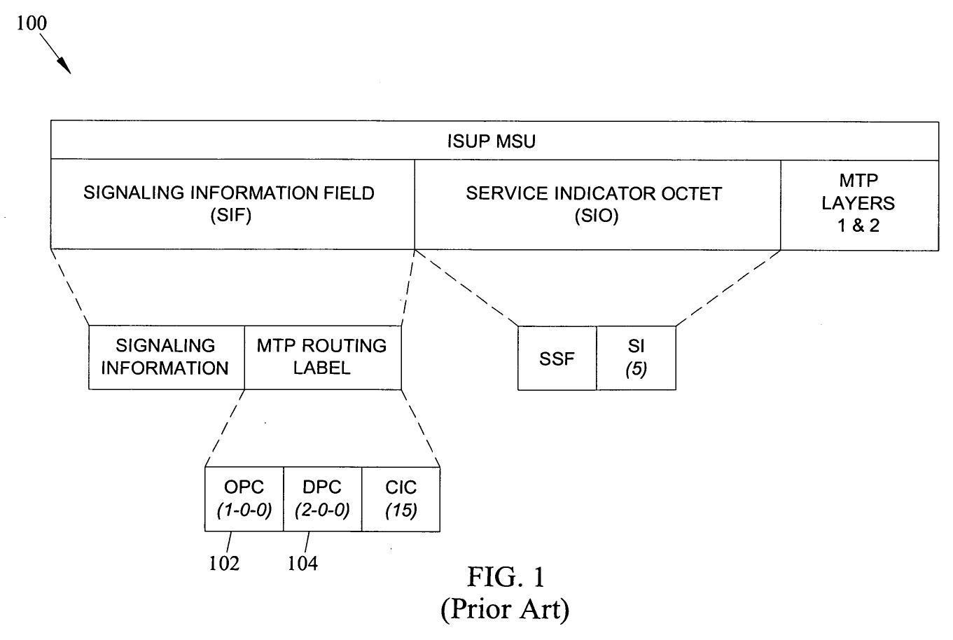

FIG. 2 is a network diagram illustrating a conventional routing strategy employed in a SS7 signaling network;

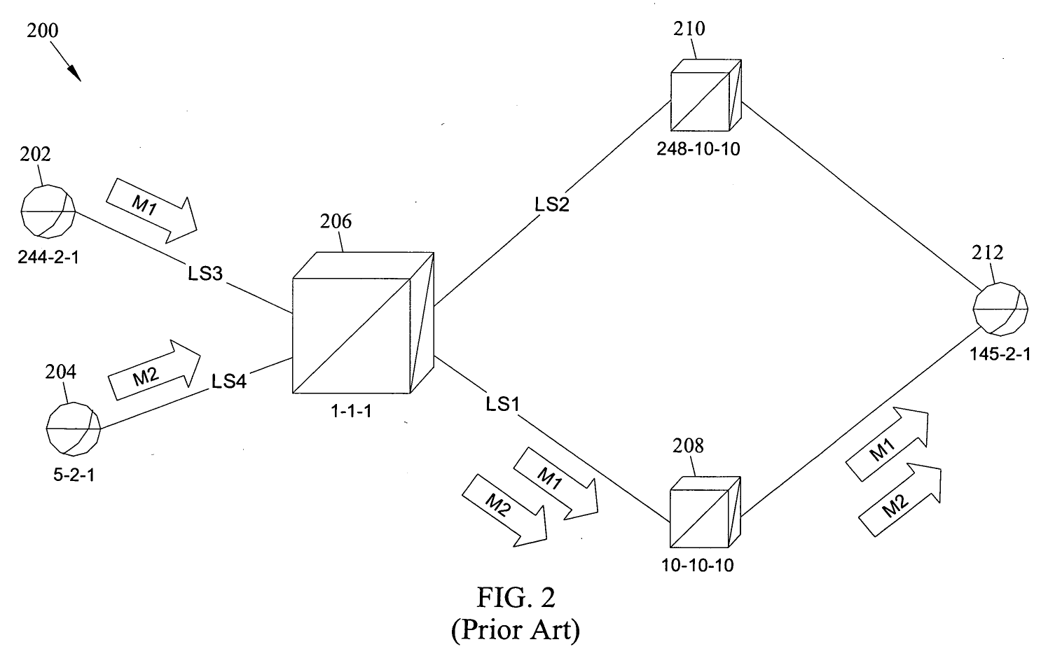

FIG. 3 is an exemplary routing table containing routing data employed in a SS7 signaling network;

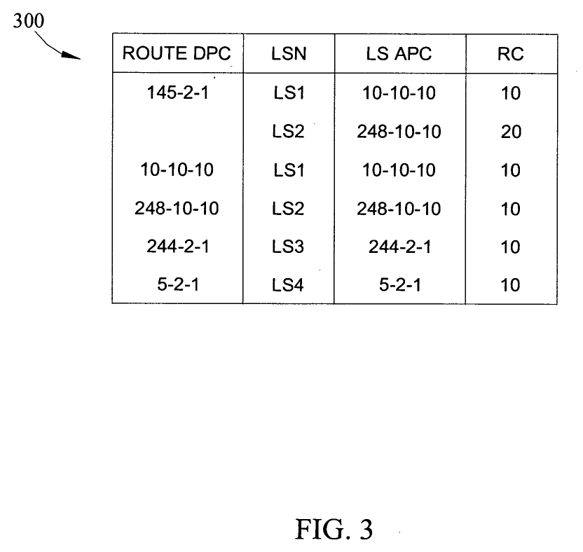

FIG. 4 is an exemplary SS7 communications network that includes network nodes that share a point code according to an embodiment of the subject matter described herein;

FIGS. 5A and 5B respectively illustrate normal and exception route tables, where the exception route table includes a no fallback indicator according to an embodiment of the subject matter described herein;

FIG. 6 is a flow chart illustrating exemplary steps for selectively limiting access to network nodes that share a point code according to an embodiment of the subject matter described herein; and

FIG. 7 is a block diagram of a signal transfer point (STP) including a routing function with fallback restriction functionality according to an embodiment of the subject matter described herein.

### DETAILED DESCRIPTION

The present subject matter relates to systems and methods for selectively limiting access to signaling network nodes that share a point code. In one embodiment, the present subject matter adds a no fallback option for origin-based message transfer part (MTP) exception routes. As used herein, an “exception route” may include any specifically designated route for transferring messages that is characterized by a predefined combination of one or more parameters and a destination point code (DPC). In one example, an exception route may be utilized to establish dedicated routes from a particular originating signaling node (e.g., a mobile switching center (MSC) or a service switching point (SSP)) to a specific destination (e.g., a service control point (SCP)). An exception route is particularly useful for allocating traffic loads when a newly introduced signaling node, which shares a point code with an existing signaling node, is placed in an established network. For example, one exception route may be provisioned to route messages from one originating node to the existing signaling point that uses the common point code and another exception route may be provisioned to route messages from another originating node to the new signaling point that uses the shared point code. Because the existing signaling node and the newly added signaling node process traffic from different originating signaling points, the total traffic load of the network is shared by the signaling points on a per-origination basis. However, if either of the signaling nodes or routes to the signaling nodes fails, it would be undesirable to allow traffic from both originations to be processed by the available signaling node because that node would likely be overwhelmed with traffic and would also fail. The subject matter described herein provides a no fallback option for exception routes that restricts traffic from falling back to a node that shares a point code with another node when either the node or a route to the node fails.

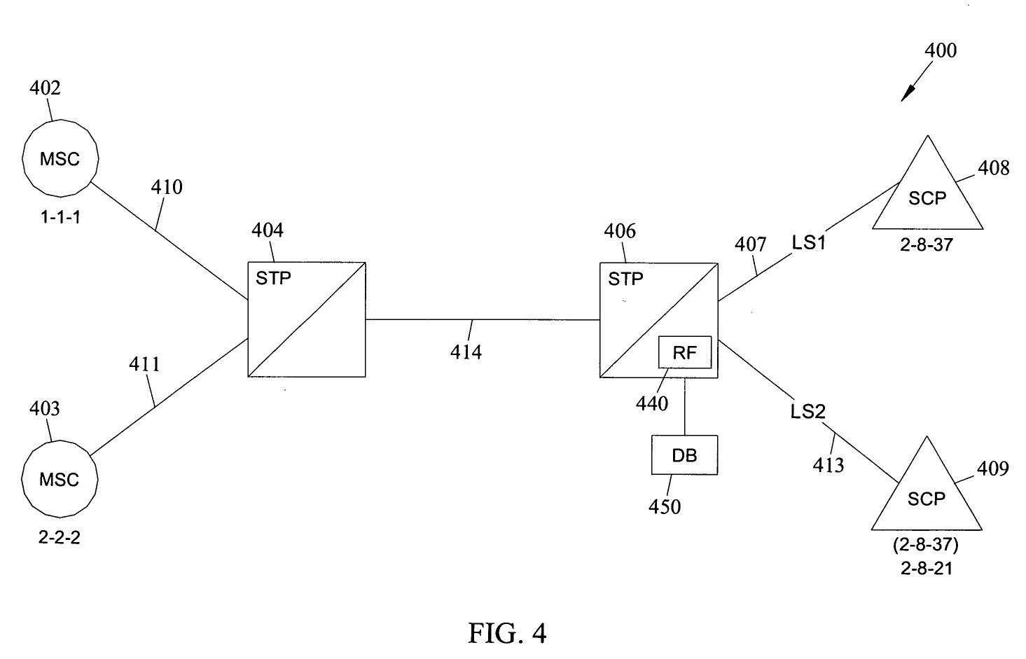

FIG. 4 illustrates an exemplary communications network 400 that includes a signaling node that share a point code according to an embodiment of the subject matter described herein. Referring to FIG. 4, network 400 may include a first mobile switching center (MSC) 402, a second MSC 403, a first signal transfer point (STP) 404, a second STP 406, a first service control point (SCP) 408, and a second SCP 409. In one embodiment, MSC 402 is connected to STP 404 via linkset 410, MSC 403 is connected to STP 404 via linkset 411, SCP 408 is coupled to STP 406 via linkset 407, SCP 409 is connected to STP 406 via linkset 413, and STP 404 and STP 406 are coupled by linkset 414. In one embodiment, SCP 408 and SCP 409 may perform the same function.

Although only two MSCs, two STPs, and two SCPs are shown in FIG. 4, network 400 may utilize any number of MSCs, STPs, and SCPs without departing from the scope of the present subject matter. STP 406 may include a one or more routing tables 450 and a routing function 452, which may be responsible for routing signaling messages and selectively limiting access to network nodes that share a point code. In one embodiment, routing function 452 may include software or firmware that is executed by a processor on STP 406.

In one embodiment, a customer may desire to expand network 400 by adding a new network component (e.g., SCP 409) in order to help alleviate increased traffic loads experienced by an existing network component (e.g., SCP 408). For example, SCP 408 may be responsible for receiving traffic from both MSC 402 and MSC 403. For the purpose of dividing the existing traffic load, SCP 409 may be added so that SCP 409 can process a portion of the signaling message traffic that would have been processed solely by SCP 408. The addition of a new signaling node may be burdensome to the network operator since signaling point originators (e.g., MSC 402 and MSC 403) present in network 400 typically need to be reprovisioned in order to communicate with the new signaling node. For example, if the new signaling node is assigned a new point code, MSCs that formerly communicated with SCP 408 must be provisioned to send messages to the new point code of SCP 409. Because network 400 may include multiple MSCs, reprovisioning each MSC or a subset of the MSCs to communicate with the new point code of SCP 409 can be labor intensive.

In order to avoid this difficulty, SCP 409 can be provisioned to use the existing point code of SCP 408. In FIG. 4, the shared point code of SCPs 408 and 409 is 2-8-37. SCP 409 may also be provisioned with an additional point code of 2-8-21 for purposes that are not relevant to the subject matter described herein.

After SCP 409 is added, traffic originating from MSC 403 may be routed to SCP 409. Likewise, traffic originating from MSC 402 may be routed to SCP 408. Thus, SCP 409 is able to alleviate the amount of traffic that originally flowed to SCP 408. This architecture also enables the network to accommodate future expansion since SCP 408 and SCP 409 are essentially sharing the bandwidth that was being handled by SCP 408 only. In one embodiment, the segregation of traffic flowing from a specific MSC (e.g., MSC 402) to a specific SCP (e.g., SCP 408) is implemented by using origin based routing and exception routes.

Generally, network 400 continues to operate in this configuration until a network component failure occurs (or another network signaling node is added). In an exemplary scenario, SCP 408 fails and becomes unavailable. In response, STP 406 sends a transfer prohibited (TFP) message to MSC 402 and not to MSC 403. The TFP message may include the point code (e.g., 2-8-37) of SCP 408 as the concerned point. In response to the TFP message, MSC 402 may cease sending messages to DPC 2-8-37 until a transfer allowed (TFA) concerning 2-8-37 message is received. MSC 403 may continue sending messages to 2-8-37, and these messages will be routed to SCP 409 on LS2 413.

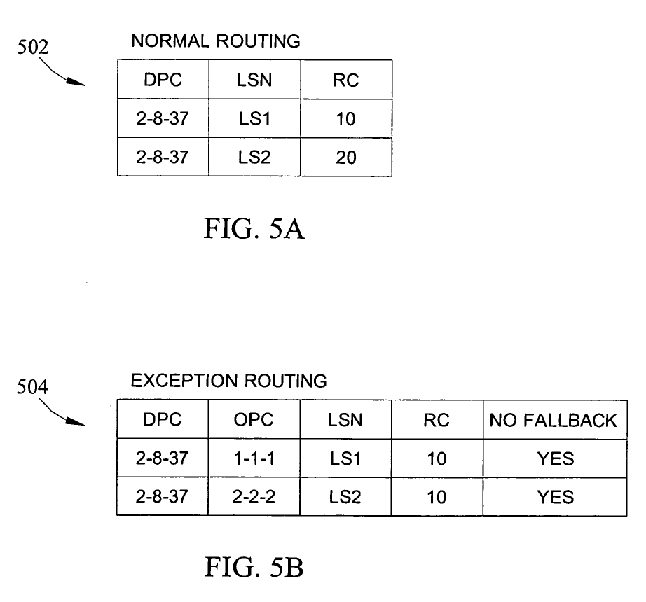

FIGS. 5A and 5B illustrate examples of normal and exception routing tables that may be used by STP 406 in routing signaling messages and restricting fallback access to signaling nodes having a shared point code according to an embodiment of the subject matter described herein. In FIG. 5A, default route table 502 contains routes that are keyed by DPC only. In FIG. 5B, exception routing table 504 contains routes that are keyed by DPC and OPC. In the illustrated example, messages with OPC 1-1-1 will reach the destination corresponding to point code 2-8-37 via linkset LS1. Similarly, messages with OPC 2-2-2 will reach the destination corresponding to point code 2-8-37 via LS2. As illustrated in FIG. 4, linksets LS1 and LS2 correspond to different SCPs.

Thus, in operation, when a message is received, a lookup is first performed in table 504 to determine whether the parameters in the message matches one of the exception routes. If the message does not match one of the exception routes, a lookup is performed in table 502 to see whether the message matches one of the default routes. Under normal STP operation, if SCP 408 or 409 becomes unavailable, the corresponding exception route will be marked as unavailable. The default route having the same linkset as the exception route would also be marked as unavailable. However, under normal STP operation, messages addressed to the DPC 2-8-37 would be able to access a default route corresponding to the available destination. If the available destination were incapable of handling the total volume of traffic formerly handled by the two destinations, the available destination would fail.

However, according to the subject matter described herein, exception routing table 504 is provided with a no fallback field that restricts access to default routes when an exception route is unavailable. In the example illustrated in FIG. 5B, if the exception route corresponding to OPC 1-1-1 becomes unavailable and the no fallback field for the exception route is set to yes, a lookup will not be performed in default routing table 502. As a result, if linkset LS1 or SCP 408 is unavailable, traffic from OPC 1-1-1 will not be routed to SCP 409 over linkset LS2. However, traffic addressed to DPC 2-8-37 that has an OPC other than 1-1-1 will still be able to reach SCP 409 via another exception route or one of the default routes. Similarly, if the exception route corresponding to OPC 2-2-2 becomes unavailable, and the no fallback field is set to yes, traffic from OPC 2-2-2 addressed to DPC 2-8-37 will not be routed to SCP 408. Traffic addressed to DPC 2-8-37 with an OPC other than 2-2-2 will still be able to reach SCP 408 via another exception route or one of the default routes. Thus, the no fallback option allows default routing with restricted access to signaling nodes that share a common destination.

Although the examples illustrated in FIGS. 5A and 5B illustrate single exception routes and single corresponding default routes, the subject matter described herein can be extended to limit access to multiple default routes on a per origination or other basis.

In addition to the above-described restricted access, by setting the no fallback option to yes, the network operator can direct its STP to generate response method network management events for the DPC based on the status of the exception routes. For example, if LS1 becomes unavailable to carry traffic, STP 406 may be configured to send transferred prohibited messages (TFPs) to MSC 402 whenever it receives traffic to DPC 2-8-37 that contains the point code of MSC 402 in the OPC field.

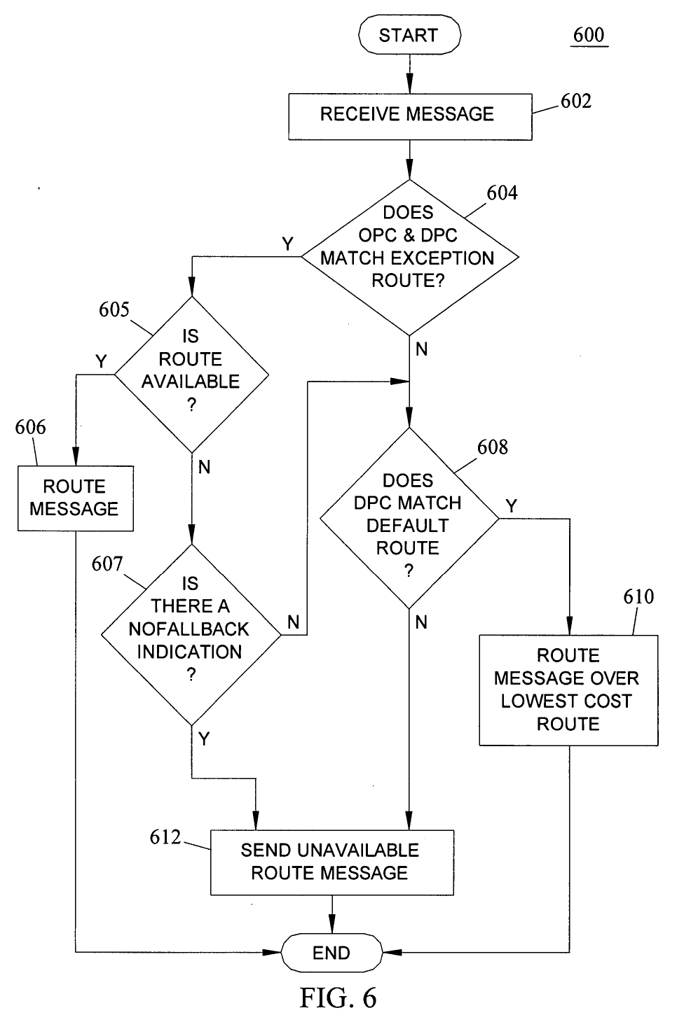

One example of utilizing the NoFallback filed of table 504 is illustrated in FIG. 6. Namely, FIG. 6 depicts a method 600 for selectively limiting access to elements in a shared network resource pool by employing the use of a NoFallback indicator. Referring to FIG. 6, in block 602, a signaling message is received. In one embodiment, a signaling node (e.g., STP 406) receives a signaling message (e.g., an MSU) intended for an SCP (e.g., SCP 408), as indicated by the DPC 2-8-37.

In block 604, a routing table is queried using the OPC and DPC of the received signaling message. Namely, a determination is made as to whether the OPC and DPC of the received message match one of the exception routes listed in table 504. If the OPC and DPC do not match one of the exception routes, then method 600 proceeds to block 608. Alternatively, if the OPC and DPC match one of the exception routes, then method 600 continues to block 605, where a determination is made as to whether or not the route is available. If the route is available, then method 600 proceeds to block 606 where the message is routed over the linkset that corresponds to the matched routing table entry. If the route is not available (e.g., the terminating signaling node has failed), then method 600 continues to block 607.

In block 607, a determination is made as to whether or not a NoFallback option is indicated. In one embodiment, STP 406 queries table 504 in order to determine if the NoFallback field indicates whether STP 406 should fallback to default table 502 (i.e., NoFallback option) due to the failure of the associated exception route. In one embodiment, a NoFallback parameter is implemented in a per origination basis (e.g., the OPC of the sending signaling node). For example, referring to FIG. 5B, both routes in table 504 indicate that the NoFallback option should be taken (i.e., that table 502 should not be referred to in the event either of the two routes should fail) since the exception routes include a “Yes” NoFallback option parameter. If a “positive” NoFallback indication is found, then method 600 proceeds to block 612, where the STP 406 simply sends a message indicating the unavailable destination. If a negative NoFallback indication is found, then method 600 continues to block 608.

In block 608, the default route table is queried using only the DPC of the signaling message to determine whether a default route applies. If the DPC matches a default route entry, method 600 continues to block 610 where the signaling message is routed over lowest cost route. If the route is not available, then the linkset with the second lowest routing cost (if applicable) is used. Alternatively, if no matching entry exists in block 608, then method 600 proceeds to block 612 where the STP 406 simply sends a message indicating the unavailable destination. Method 600 then ends.

Accordingly, providing an exception route with an indicator for controlling whether or not to fall back to a default route affords more precise control over which signaling nodes may have access to a shared resource (e.g., SCP 408 and SCP 409). In one embodiment, multiple exception routes may be added to table 504 to allow or deny access to the default route on a per-origination basis.

In prior routing solutions, the OPC and DPC (and possibly other message parameters) values contained in a signaling message are used to select one of many routes to the signaling node associated with the specified DPC. One aspect in which the present subject matter differs from prior OPC routing solutions is that the present subject matter limits access to a resource in a shared pool of resources based on the point code of the originating node (or some other parameter). More importantly, the present subject matter enables resources in the pool to share a point code, thereby eliminating the need to reprovision originators that access the resources when a new resource is added to the pool.

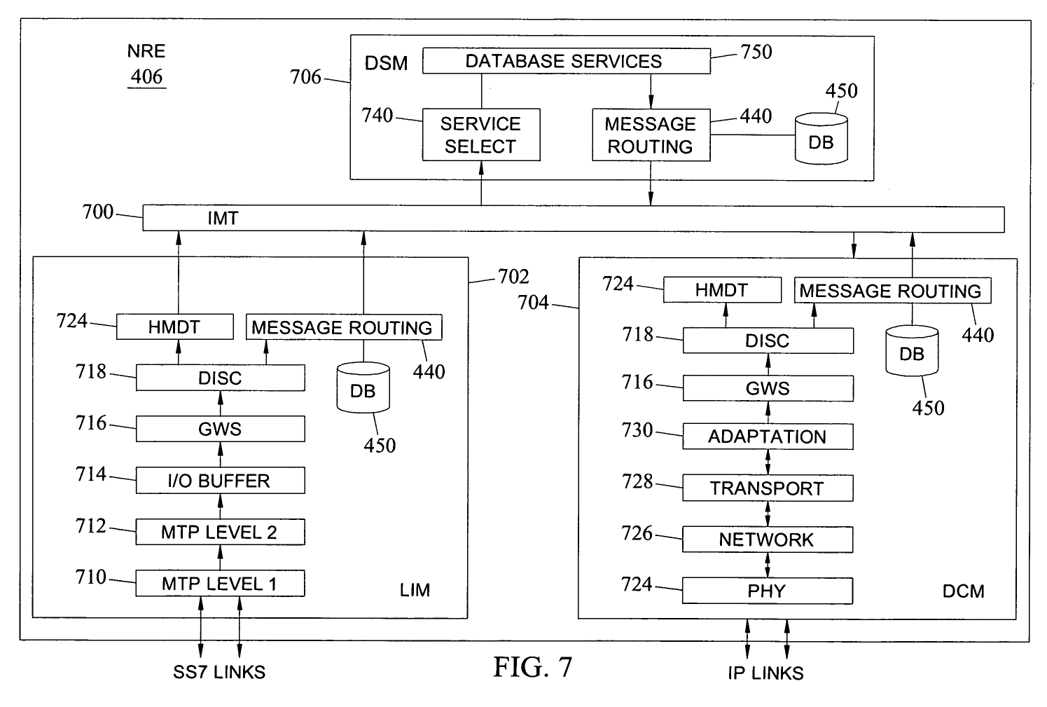

Shown in FIG. 7 is an exemplary internal architecture of a network signaling node or network routing element (e.g., STP 406) that may be used with embodiments of the present subject matter. Referring to FIG. 7, STP 406 includes an interprocessor message transport (IMT) bus 700 that is the main communication bus among internal subsystems within STP 406. In one embodiment, this high-speed communications system includes two counter-rotating serial rings. A number of processing modules or cards may be coupled to IMT bus 700. In FIG. 7, IMT bus 700 may be coupled to a link interface module (LIM) 702, a data communications module (DCM) 704, and a database service module (DSM) 706, which includes routing function 455. These modules are physically connected to IMT bus 700 such that signaling and other types of messages may be routed internally between active cards or modules. For simplicity of illustration, a single LIM card, a single DCM card, and a single DSM card are included in FIG. 7. However, STP 406 may include multiple other LIMs, DCMs, and DSMs, and other cards, all of which may be simultaneously connected to and communicating via IMT bus 700.

Each module 702, 704, and 706 may include an application processor and a communication processor. The communication processor may control communication with other modules via IMT bus 700. The application processor on each module may execute the applications or functions that reside on each module. For example, the application processor on DSM 706 may execute software that implements routing function 455. Similarly, the application processor on LIM 702 may execute software that implements a screening function for determining whether messages should be forwarded to DSM 706 for application to an IMS offload function.

LIM 702 may include an SS7 MTP level 1 function 710, an SS7 MTP level 2 function 712, an I/O buffer 714, a gateway screening (GWS) function 716, an SS7 MTP level 3 message handling and discrimination (HMDC) function 718, including an application screening function 720, routing function 440 and associated routing database 450, and a message handling and distribution (HMDT) function 724. MTP level 1 function 710 sends and receives digital data over a particular physical interface. MTP level 2 function 712 provides error detection, error correction, and sequenced delivery of SS7 message packets. I/O buffer 714 provides temporary buffering of incoming and outgoing signaling messages.

GWS function 716 examines received message packets and determines whether the message packets should be allowed in network routing element 108 for processing and/or routing. HMDC function 718 performs discrimination operations, which may include determining whether the received message packet requires processing by an internal processing subsystem or is simply to be through switched (i.e., routed on to another node in the network). Messages that are permitted to enter STP 406 may be routed to other communications modules in the system or distributed to an application engine or processing module via IMT bus 700. Routing function 440 may route received messages that are identified by discrimination function 718 as requiring routing to the appropriate LIM or DCM associated with the message destination. Exemplary routing criteria that may be used by routing function 440 to route messages include the routing data illustrated in Tables 5A and 5B. Message handling and distribution (HMDT) function 724 distributes messages identified by discrimination function 718 as requiring further processing to the appropriate processing module within STP 406 for providing the processing.

DCM 704 includes functionality for sending and receiving SS7 messages over IP signaling links. In the illustrated example, DCM 704 includes a physical layer function 724, a network layer function 726, a transport layer function 728, an adaptation layer function 730, and functions 716, 718, 720, 722, and 724 described above with regard to LIM 702. Physical layer function 724 performs open systems interconnect (OSI) physical layer operations, such as transmitting messages over an underlying electrical or optical interface. In one example, physical layer function 724 may be implemented using Ethernet. Network layer function 726 performs operations, such as routing messages to other network nodes. In one implementation, network layer function 726 may implement Internet protocol. Transport layer function 728 implements OSI transport layer operations, such as providing connection oriented transport between network nodes, providing connectionless transport between network nodes, or providing stream oriented transport between network nodes. Transport layer function 728 may be implemented using any suitable transport layer protocol, such as stream control transmission protocol (SCTP), transmission control protocol (TCP), or user datagram protocol (UDP). Adaptation layer function 730 performs operations for sending and receiving SS7 messages over IP transport. Adaptation layer function 730 may be implemented using any suitable IETF or other adaptation layer protocol. Examples of suitable protocols include Tekelec's transport adapter layer interface (TALI), MTP level 2 peer-to-peer user adaptation layer (M2PA), MTP level 3 user adaptation layer (M3UA), and/or signaling connection control part (SCCP) user adaptation layer (SUA). Functions 440, 450,716,718,720,722, and 724 perform the same operations as the corresponding components described above with regard to LIM 702. Because STP 406 includes SS7 over IP processing capabilities, STP 406 can also be considered an SS7/IP signaling gateway.

Database services module 706 performs database related services for received signaling messages identified by discrimination function 518 as requiring further processing. Examples of database services that may be provided include global title translation and number portability translation. Database services module includes a service selection function 740 that selects an appropriate database service to be applied to a received message in a database services function 750 for providing the appropriate database service. After the database service has been provided, routing function 440 may perform a lookup in routing database 450 to determine the appropriate LIM or DCM associated with the outbound signaling link.

Thus, in operation, when a message is received by STP 406, the message is passed up the appropriate protocol stack to routing function 440. Routing function 440 performs a lookup in routing database 450 to determine the module associated with the outbound signaling link. The message is then routed to the module associated with the outbound signaling link. Because the no fallback option is implemented in routing database 450, messages addressed to a shared point code will not fallback from an exception route to a default route. Accordingly, new nodes can be added to the network that share a point code of an existing node without risking failure of both nodes when of the nodes fails.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for selectively limiting access to signaling nodes that share a point code, the method comprising:
provisioning at least a first destination node and a second destination node in a communications network to be identified by a common point code;
routing messages to the first and second destination nodes respectively using first and second exception routes that are keyed by different combinations of parameters that include the common point code as a destination point code (DPC);
providing at least one default route to the first and second destination nodes;
detecting failure of at least one of the first exception route and the first destination node; and
in response to detecting the failure, restricting fallback access to the second destination node via the at least one default route.

2. The method of claim 1 wherein provisioning at least a first destination node and a second destination node to be identified by a common point code includes adding the second destination node to a network that includes the first destination node so that the second destination node can process a portion of the message traffic addressed to the common point code that would have been directed to the first destination node.

3. The method of claim 2 wherein routing messages to each of the first and second destination nodes respectively using first and second exception routes includes routing messages addressed to the common point code from a first originating node to the first destination node via the first exception route and routing messages addressed to the common point code from a second originating node to the second destination node via the second exception route.

4. The method of claim 3 wherein the first and second originating nodes comprise mobile switching centers and wherein the first and second destination nodes comprise service control points.

5. The method of claim 3 wherein restricting fallback access to the second destination node via that at least one default route includes preventing messages originating from the first originating node from being routed to the second destination node via the at least one default route.

6. The method of claim 1 wherein routing messages to each of the first node and the second node respectively using first and second exception routes includes routing the messages using first and second routing table entries respectively corresponding to the first and second exception routes.

7. The method of claim 6 wherein the first routing table entry is keyed by a combination of a first originating point code and the common point code as the destination point code and wherein the second routing table entry is keyed by a second originating point code and the common point code as the destination point code.

8. The method of claim 1 wherein providing at least one default route includes providing a first default route keyed by the common point code as a DPC and a second default route keyed by the common point code as a DPC, wherein the first and second destination nodes are respectively accessible via the first and second default routes, and wherein the first and second default routes have different route costs.

9. The method of claim 1 wherein the routing, providing, detecting, and restricting steps are performed at a signal transfer point (STP).

10. The method of claim 1 wherein the routing, providing, detecting, and restricting steps are performed at an SS7/IP signaling gateway.

11. The method of claim 1 wherein the first and second nodes provide redundant processing capabilities.

12. A system for selectively limiting access to signaling nodes in a communications network, the system comprising:
first and second destination nodes identified by a common point code; and
a routing node for routing messages to the first and second destination nodes using first and second exception routes that are keyed by different combinations of parameters that include the common point code as a destination point code (DPC), for providing at least one default route to the first and second destination nodes, for detecting failure of at least one of the first exception route and the first destination node, and, in response to detecting the failure, for restricting fallback access to the second destination node via the at least one default route.

13. The system of claim 12 wherein the second destination node is adapted to process a portion of the message traffic addressed to the common point code that would have been directed to the first destination node.

14. The system of claim 13 wherein the routing node is adapted to route messages addressed to the common point code from a first originating node to the first destination node via the first exception route and to route messages addressed to the common point code from a second originating node to the second destination node via the second exception route.

15. The system of claim 14 wherein the first and second originating nodes comprise mobile switching centers and wherein the first and second destination nodes comprise service control points.

16. The system of claim 14 wherein the routing node is adapted to restrict the fallback access by preventing messages from the first originating node from being routed to the second destination node via the at least one default route in response to detecting the failure.

17. The system of claim 14 wherein the routing node includes a first route table entry keyed by an originating point code (OPC) corresponding to the first originating node and a DPC corresponding to the common point code and a second entry keyed by an OPC corresponding to the second originating node and a DPC corresponding to the common point code.

18. The system of claim 12 wherein the routing node is adapted to provide a first default route keyed by the common point code as a DPC and a second default route keyed by the common point code as a DPC, wherein the first and second destination nodes are respectively accessible via the first and second default routes, and wherein the first and second default routes have different route costs

19. The system of claim 12 wherein the routing node comprises a signal transfer point (STP).

20. The system of claim 12 wherein the routing node comprises an SS7/IP gateway.

21. A computer program product comprising computer executable instructions embodied in a computer readable medium for performing steps comprising:
provisioning at least a first destination node and a second destination node in a communications network to be identified by a common point code;
routing messages to the first and second destination nodes respectively using first and second exception routes that are keyed by different combinations of parameters that include the common point code as a destination point code (DPC);
providing at least one default route to the first and second destination nodes;
detecting failure of at least one of the first exception route and the first destination node; and
in response to detecting the failure, restricting fallback access to the second destination node via the at least one default route.
